(19) United States
(12) Patent Application Publication
(10) Pub. No.: US 2009/0064387 A1
(43) Pub. Date: Mar. 12, 2009

(54) METHOD FOR MAKING A PROTECTIVE GARMENT AND RESULTING PROTECTIVE GARMENT

(75) Inventors: Philippe Jaunault, Villemoisan (FR); Sophie Jaunault, Villemoisan (FR); Franck Beneteau, Champtoce Sur Loire (FR)

Correspondence Address: YOUNG & THOMPSON, 209 Madison Street, Suite 500, ALEXANDRIA, VA, 22314, US

(73) Assignee: MANULATEX FRANCE, Champtoce sur Loire (FR)

(21) Appl. No.: 12/282,090

(22) PCT Filed: Mar. 6, 2007
(86) PCT No.: PCT/FR07/50884

§ 371 Date: Sep. 8, 2008

(30) Foreign Application Priority Data
Mar. 7, 2006 (FR) 0602002

(51) Int. Cl. A41D 13/04; A41D 19/00; C21D 1/00; B23P 11/00

(52) U.S. Cl. 2/48; 2/102; 2/159; 148/516; 29/428

(57) ABSTRACT

The invention concerns a particular method of making a protective garment or a part of a protective garment, such as a glove, an apron, a vest or the like, said garment or part of garment comprising a web of metal particles assembled together, such as a web of interleaved metal rings or a web of metal platelets assembled by metal linking rings or the like.

The method according to the invention is characterized in that it consists in the following steps:
firstly, starting with structurally hardened metal or metals not thermally treated, carrying out operations of metal particle cutting, shaping and possibly assembling,
secondly, heat treating said obtained particles or said metal web obtained after the assembling operation, so as to increase strength and hardness characteristics of the metal particles constituting said web,
and finally carrying out a final operation of making the protective garment or finalizing the garment.

The present invention relates to a method of making a protective garment, such as a glove, an apron, a vest or the like, or a part of such a garment, comprising a web of metal particles assembled together.

Protective garments used in certain industries (notably the meat industry) or for the protection of persons against projectile (bullet, etc.) or knife attacks frequently use metal particle webs particularly appreciated for their intrinsic qualities of cut or perforation resistance.

These metal particle webs consist of coat of mail fabrics formed by interweaving of metal rings, or an assembly of metal platelets by means of also metal rings.

Generally speaking, these particles (rings and/or platelets) are made of stainless steel or aluminum.

Given the sought protective function, it is desired to obtain webs having optimal strength and security characteristics.

The possibility of using very hard and very strong metals is however limited by the web making techniques, especially the necessary operations of metal particle cutting, drawing, forming, bending and/or welding.

So until now, in the concerned technical field, steels (316L, 304L, etc.) or aluminum alloys (3000 and 5000 series, for example AG 3 (5754)) are used, the strength and hardness characteristics of which are at the cutting, shaping and welding capability limits of the particles constituting the aforementioned webs.

Very hard and very strong metals are not used which could enable obtaining webs having higher strength and hardness properties than conventional webs, or having similar properties, but with a lighter weight because a smaller thickness would be used.

The present invention offers a remedy to that drawback through using, as a base material for making the metal particles, of structurally hardened metal(s), namely metal(s) presenting in a certain state relatively low strength and hardness characteristics and, in any case, compatible with the metal particle cutting and shaping operations (and possibly the metal web forming operation) and presenting, after a heat treatment, far higher strength characteristics, especially higher than those compatible with the aforementioned cutting/shaping (and possibly forming) operations.

The heat treatment in question is advantageously performed after the most extensive possible shaping of the metal particles or of the metal web according to the desired structure in the finally aimed garment.

Interestingly, within the scope of a web totally made of a structurally hardened metal material (for example a web of rings such as a coat of mail or platelets assembled by linking rings), the heat treatment is advantageously carried out on said finished web, after the constitutive metal particles thereof are assembled together.

Within the scope of the present invention, the heat treatment can still be performed on the individual shaped metal particles (especially within the scope of metal platelets used to form the web), these particles being next only assembled to form the web.

The heat treated web is possibly not totally in the form that is used for making the final garment. In this case, the corresponding web is finalized by any technique appropriate to the strength and hardness of the metal particles. For example, if this conforming finalization requires provision of metal attaching rings, these rings can be made of a conventional stainless steel the properties of which satisfy to the standards in force and which can be bent without being dominantly harmful to the strength of the web assembly.

Preferably, before the metal particles or the web are shaped, according to the case, the metal in question is subjected to a mechanical deformation/elongation, such as kneading, which enables obtaining a work hardening of said metal adapted to approach the shaping capability limits of said particles (according to the available equipments and techniques). This particularity enables optimizing the later heat treatment to obtain the highest possible strength and hardness characteristics.

Any type of structurally hardened material can be used, provided that the strength and hardness characteristics thereof before heat treatment enable metal particle shaping, and that the strength and hardness characteristics thereof are optimized after said heat treatment. These optimized strength and hardness characteristics enable the obtained material to be broadly compatible with agri-food standards (the energies of which are in the order of 5 joules); they can even enable this material to enter in conformity with some relatively strict standards, such as standards relative to knife protective garments (the energies of which are, according to the levels, between 25 and 60 joules).

As an example, it is possible to use a structurally hardened stainless steel derived from nanotechnology research, which use the principle of formation of nanoparticles during heat treatment of the material. These extremely hard nanoparticles provide to the material hardness as well as strength, two properties normally opposed in physics.

This type of steel has also interesting qualities of abrasion resistance and ductility before heat treatment.
As an example again, it is possible to use—a Z8 CNT 17.7 stainless steel (AFNOR standard), or—a 2000, 6000 or 7000 series (especially 7075 series) aluminum alloy.

The heat treatment of the metal particles or of the particle web (or possibly of the half-finished or finished garment) is performed within a sealed furnace.

After the product to be treated is disposed into the furnace, a thorough vacuum is done to fully eliminate oxygen. Thereafter, the heat treatment is performed either under vacuum either after replacement of air by another inert gas or a mixture of inert gas (for example, Argon or Argon+Hydrogen).
Duration and temperature of the treatment are function of the characteristics of the metal that is used.
For example, the temperature rising can last one hour; the treatment duration can be of 3 to 6 hours at a temperature comprised between 400 and 600° C. (depending on the used metal(s)), followed by a cooling of 2 to 5 hours, the totality of the treatment up to the cooling being performed under vacuum or under an inert gas.

Depending on the metal that is used, the obtained metal web can have strength and hardness characteristics 1.1 to 2 times, or more, higher than those of the same webs made of conventional steel or aluminum.

As aforementioned, it is possible either to take advantage of these optimal hardness/strength characteristics either to develop webs that have strength and hardness characteristics similar to those of the prior art, but with a lighter weight by surface area (a particularly important characteristic in the field of protective garment).

The metal web according to the invention can be a coat of mail obtained from a structurally hardened metal wire, such as stainless steel or aluminum alloy, to perform the shaping of protective gloves (with or without cuff), aprons, for example for the meat industry, or protective vests. These vests can be bulletproof or knife-proof vests in which the coat of mail forms one of the protective layers, possibly in association with one or more plies of technical fabrics and/or another conventional material. This coat of mail layer is integrated inside the vest by any appropriated means; for example, it is fixed by removable attaching means such as self-locking strip(s) or snap fastener(s).

The web according to the invention can also be made of metal platelets (generally rectangular, circular or the like), assembled together by linking rings (or another linking means), to form protective aprons, notably but not exclusively for the meat industry.

In this case, the platelets and the linking wire can both be made of a structurally hardened metal, notably a stainless steel or an aluminum alloy (in this case, the heat treatment is advantageously performed after the web is assembled).
It is also conceivable to use platelets made of a structurally hardened metal (stainless steel or aluminum alloy), on which the heat treatment has been carried out before they are assembled by means of conventional metal rings (or another means), notably made of a conventional stainless steel.

1. Method of making a protective garment or a part of a protective garment, such as a glove, an apron, a vest or the like, said garment or part of garment comprising a web of metal particles assembled together, such as a web of interleaved metal rings or a web of metal platelets assembled by metal rings or the like, said method comprising the following steps:
cutting and shaping said metal particles,
assembling together said metal particles to obtain said sought particle web, and
finally, from said obtained web, making said sought protective garment or finalizing the making of said garment, characterized in that the method consists:
starting from structurally hardened metal or metals not thermally treated, in carrying out at least said steps of metal particle cutting and shaping,
then heat treating said obtained particles or said metal web obtained after said assembling step, so as to increase strength and hardness characteristics of the metal particles constituting said web,
and finally carrying out said final step of making the protective garment or finalizing the garment.

2. Method according to claim 1, characterized in that it consists in performing a mechanical crushing/elongation of the used metal, such as kneading, before the metal web is shaped, said heat treatment being done to obtain a work hardening of the metal the strength and hardness characteristics of which are adapted to the limit values of the cutting, shaping and possibly welding capabilities of the metal particles.

3. Method according to claim 1, characterized in that it consists in heat treating the metal particles or the metal web in an appropriate furnace, during several hours, at a temperature comprised between 400 and 600° C.

4. Method according to claim 3, characterized in that the heat treatment is performed under inert gas, after primary vacuum in the treatment furnace.

5. Method according to claim 3, characterized in that the heat treatment is performed under vacuum, in particular in absence or quasi-absence of oxygen.

6. Method according to claim 1, characterized in that it consists, starting with a structurally hardened metal wire not thermally treated, in making a web of interleaved metal rings forming a coat of mail fabric, and then performing the heat treatment.

7. Method according to claim 6, characterized in that it consists, starting with a structurally hardened stainless steel wire, in making a web of interleaved metal rings forming a coat of mail fabric.

8. Method according to claim 6, characterized in that it consists, starting with a structurally hardened aluminum alloy wire, in making a web of interleaved metal rings forming a coat of mail fabric.

9. Method according to claim 1, characterized in that it consists, starting with stainless steel platelets and a stainless steel wire, both structurally hardened and not heat treated, in making a web of metal platelets assembled together, and then performing the heat treatment.

10. Method according to claim 1, characterized in that it consists, starting with structurally hardened metal material platelets subjected to their final heat treatment, in making the assembling thereof by means of rings or the like made of a conventional stainless steel wire.

11. Method according to claim 10, characterized in that it consists, starting with structurally hardened stainless steel platelets subjected to their final heat treatment, in making the assembling thereof by means of rings or the like made of a conventional stainless steel wire.

12. Method according to claim 10, characterized in that it consists, starting with structurally hardened aluminum alloy platelets subjected to their final heat treatment, in making the assembling thereof by means of rings or the like made of a conventional stainless steel wire.

13. Protective garment such as a glove, an apron or a vest comprising a coat of mail fabric obtained by the method according to claim 6.

14. Protective garment such as an apron or a vest comprising a web of metal platelets assembled together obtained by the method according to claim 9.

15. Method according to claim 2, characterized in that it consists in heat treating the metal particles or the metal web in an appropriate furnace, during several hours, at a temperature comprised between 400 and 600° C.

16. Method according to claim 2, characterized in that it consists, starting with a structurally hardened metal wire not thermally treated, in making a web of interleaved metal rings forming a coat of mail fabric, and then performing the heat treatment.

17. Method according to claim 2, characterized in that it consists, starting with stainless steel platelets and a stainless steel wire, both structurally hardened and not heat treated, in making a web of metal platelets assembled together, and then performing the heat treatment.

18. Method according to claim 2, characterized in that it consists, starting with structurally hardened metal material platelets subjected to their final heat treatment, in making the assembling thereof by means of rings or the like made of a conventional stainless steel wire.
